(19) United States
(12) Patent Application Publication
(10) Pub. No.: US 2012/0047070 A1
(43) Pub. Date: Feb. 23, 2012

(54) ATM/KIOSK Cash Acceptance

(76) Inventor: Jennifer Pharris, Tomball, TX (US)

(21) Appl. No.: 12/969,667

(22) Filed: Dec. 16, 2010

Related U.S. Application Data
(63) Continuation-in-part of application No. 12/412,193, filed on Mar. 26, 2009.
(60) Provisional application No. 61/041,723, filed on Apr. 2, 2008.
(60) Provisional application No. 61/127,314, filed on May 12, 2008.

(51) Int. Cl. G06Q 40/02; G06Q 20/16; G06Q 20/18; G06Q 20/32; G06Q 20/10

(52) U.S. Cl. 705/43; 705/42

(57) ABSTRACT

In one aspect, this invention relates to a new method for using a mobile telephone, in conjunction with a payment transaction server, as an authentication and cash payment device of a cash deposit made into an ATM/KIOSK for a variety of financial transactions where a cash payment is desired. Further, the transaction systems and methods for mobile telephone devices described herein allow a mobile telephone to participate in payment transactions in a manner that helps prevent identify theft and without relying on transferring amounts to/from one stored value account to another. It is emphasized that this abstract is provided to enable a searcher to quickly ascertain the subject matter of the technical disclosure and is submitted with the understanding that it will not be used to interpret or limit the scope or meaning of the claims.

### CROSS-REFERENCE TO RELATED APPLICATIONS

This application is a continuation-in-part of U.S. patent application Ser. No. 12/412,193 and claims priority to U.S. patent application Ser. No. 12/412,193, filed Mar. 26, 2009, U.S. Provisional Patent Application Ser. No. 61/041,723, filed Apr. 2, 2008, and U.S. Provisional Patent Application Ser. No. 61/127,314, filed on May 12, 2008. The entire contents of U.S. patent application Ser. No. 12/412,193 and both provisional applications are incorporated herein by reference.

### FIELD OF THE INVENTION

Embodiments of the invention generally provide transaction systems and methods for mobile telephone devices. More specifically, embodiments of the invention allow a mobile telephone, in conjunction with a payment transaction server and an ATM/KIOSK, to be directly used as a cash payment device for a variety of financial transactions.

### BACKGROUND OF THE INVENTION

11.1 million adults were victims of identity theft in 2009. The total fraud amount was $54 billion. Approximately, $32.4 Billion was lost due to stolen or fake credit cards. The average victim spent 21 hours and $373 out of pocket resolving the crime. Exposure of actual credit card numbers and the use of physical credit cards offer opportunities to credit card thieves.

Exposure: People carry their physical credit cards in their wallet and pull them out for almost every transaction! Static Numbers: How long have you had the same credit card number? (years!). Described below is a recent Wall Street Journal article titled “ATM Fraud Gets Even More Brazen” dated Nov. 27, 2010, which provides the perfect background for disclosure of applicant's invention:

Fraud involving debit cards and personal-identification numbers is on the rise as criminals go where the cash is—even targeting banks' own automated teller machines.

Techniques such as “skimming,” in which criminals capture card information and personal-identification numbers, have existed for years, often on a small scale. Though the dollar losses still are relatively modest, organized gangs now are pulling off more-sophisticated attacks.

They also are targeting bigger players: Whereas most of the fraud in previous years took place at independent ATMs or at retail points of sale, fraud at bank-owned ATMs made up more than 80% of the breaches in the first six months of this year, says Fair Isaac, which provides fraud-detection software.

Europe, which has faced a bigger problem than the U.S., saw card-skimming ATM attacks jump 24% in the first six months of this year, to 5,743, the largest six-month number since data-gathering began in 2004, according to the European ATM Security Team, a nonprofit group. (Losses from skimming fell 8%, to [symbol] 144 million, or $197 million.)

Attacks on retailers continue to climb as well. Last month, supermarket chain Aldi said it had discovered that payment terminals in major U.S. cities in 11 states had been altered to allow the skimming of card numbers, cardholder names and PINs between June 1 and August 31 this year.

Avivah Litan, fraud analyst at Gartner, a research firm, estimates that fraud involving debit cards, PINs and point-of-sale equipment has surged 400% over the past five years. One tactic, she says, has been “flash attacks”: Using the stolen information, gangs create thousands of counterfeit debit cards and then dispatch cronies to at least 100 ATM machines in several cities at once. Each withdraws a small dollar amount from several accounts to avoid fraud-detection software, adding up to tens of thousands of dollars in losses.

Until recently, skimming equipment was relatively crude and clunky, attached to card-readers with double-stick foam tape and relying on small cameras to record hands punching in PINs. Newer devices include equipment that fits inside card readers, pinhead-sized cameras and well-crafted attachments that sit snugly on top of ATM card readers and PIN pads, looking just like the real equipment. Bluetooth technology allows the fake card reader and PIN pad to talk to each other, and data drives or wireless technology can make downloading of stolen information quick and easy.

Given such clever engineering, consumers may not be able to tell that a machine has been compromised. Banks may not know either: Fair Isaac says that perpetrators of such fraud often place skimmers on outdoor ATMs on Saturday mornings and remove them before the bank opens Monday. The data is typically passed to crooks in another country within hours.

Better technologies are available: Canada and several European countries, among others, have adopted so-called chip-and-PIN debit cards, with chips built into the card, adding a layer of protection. But American banks and retailers have resisted adopting the technology because it is expensive to replace cards, ATMs and point-of-sale machines.

The chip-and-PIN technology isn't foolproof, and experts say U.S. banks and retailers may instead leapfrog that technology, possibly by using the capabilities of smartphones to verify transactions or to actually make the transactions instead of using a card.

Given scammers' growing sophistication, consumers are at a disadvantage. But there are some steps you can take—beyond becoming an expert in equipment design and appearance—to avoid the traps or lessen the impact if your information is stolen:
The simplest protection, says the American Bankers Association, is to get in the habit of covering up your hand when you enter your PIN so that a camera can't record what you are typing.
Use an indoor ATM. Because they are less isolated, indoor ATMs are less likely to be tampered with than outdoor machines.
Use your PIN sparingly at retailers, and choose the signature option—or a credit card—instead, Ms. Litan says.
If you don't have time to check your bank account regularly, set up email or text alerts to send you balances weekly or, if you are particularly paranoid, daily, so that you will know sooner if something is amiss. Most banks will refund your losses promptly, but you need to report the violation quickly, preferably within two days and no later than 60 days after receiving a statement showing the fraud.
You should add your bank's and credit card's customer-service numbers to your contacts so you can access them from both your email and cellphone. Having the numbers at hand will eliminate the frustration of trying to find them when you are traveling or at a public computer.
If your bank suspects fraud, it needs to be able to reach you quickly. Make sure it has your cellphone number as well as your email address and that your other information is up to date. Taking my own advice, I discovered that my bank had home and work phone numbers that were more than a decade out of date.

### SUMMARY OF THE INVENTION

Applicant's invention discloses a software application that, once downloaded onto a customer's mobile phone with text messaging capability, allows that customer to send money to or receive money from other mobile phones that have the application and to pay for goods and services, without having to disclose any of their credit card or account information at the time of transfer or payment. A customer initially visits an ATM/KIOSK, an authorized local bank, or a telephone company (i.e. AT&T, Verizon, SPRINT, and the like, hereinafter “telco”) operator's outlet for a one time upload onto a proprietary network operated by the bank or telco of their driver's license, personal checking account information, and credit cards used by the customer. All of this information is maintained by an authorized agent. No customer information is transferred across the internet. Once the customer has established a “pin” code, the customer's cell phone number and an account number make up the ACCESS number for others to transfer money to the customer authenticated by the customer's cell phone. Customers initiate payment transactions using the mobile application and the existing banking system does the actual transferring of funds.

Once the customer has completed the upload of their information at an ATM/KIOSK, at an authorized bank , or at a telco, cash can be deposited into the ATM/KIOSK and can be transferred to another customer's mobile device. Alternatively, it can be used to pay for goods or services, the product can use a Data Matrix 2-D, Code 39 or Code 128 barcode, and the like, that is sent via the instant text message system to the customer's mobile device. The barcode is scanned by the merchant for payment for goods and services. A separate pay code can also sent via the instant text message system in case a merchant scanner is not available and for use in making purchases over the internet. Each barcode or pay code may be generated for only that one purchase for a maximum of predetermined time period (for example, 900 seconds) which provides greater security than using a credit card. When the merchant scans the bar code or enters the pay code for payment, the customer receives a text message detailing the merchant and amount being charged to the customer's credit card or bank account for added security. The customer must “accept” the payment using their cell phone or other mobile device for the transaction to be completed. All of this is designed to happen in seconds, so there is no delay for the merchant or customer.

Revenue is generated by monetizing various mobile financial transactions made possible by the mobile application which may be made operable on the iPhone, Blackberry, Android and Windows mobile platforms, and the like. Each of these activities creates a fee opportunity for the agent and affiliated financial institutions, telcos and merchants. Example fees may range from $0.25 to $2 per transaction depending on the amount of the transaction and may be fixed fees or a percentage of the dollar value of the transaction. In addition to the transaction fees, the application screens on the mobile phones can offer a platform for participating financial institutions to derive additional revenue through advertising, gift certificates, loyalty cards and couponing. Coupons can be made available to consumers through participating merchants that offer attractive sale programs and discounts. Fees may be obtained from this process paid by merchant's gift certificate, loyalty cards, and coupon companies.

In a peer to peer money transfer, either a flat fee can be assessed or a nominal percentage of the amount of the transferred funds can be imposed (similar to how Western Union currently extracts a fee for funds transferred). The financial institutions actually make the funds transfers, directly or on behalf of telcos, and the agent receives a fee because the transaction was initiated using the agent's mobile application. The interbank and intrabank funds transfers will create expanded interchange fee opportunities that both the bank and the agent can share. This will be a highly attractive option for banks to recoup interchange fees. There are millions of these transactions every month that could be completed using applicant's invention. The fees are expected to be a fraction of current charges due to automation efficiencies thus providing considerable price appeal to consumers over Western Union, for example, especially for the vast majority of the people who need the service most. Participating financial institutions and telcos now have access to the vast group of “the underbanked” (i.e. potential customers who do not have any banking relationship). Now these folks will have an opportunity to inexpensively send cash to their loved ones, merchants, vendors, businesses, and other payees.

The agent can generate additional fee income with its own distribution chain of customized ATM/KIOSK Cash Acceptance machines that enable the customer to transfer funds, deposit funds, and pay bills efficiently and cheaply. It is a win win. It is contemplated that the agent can establish a network of participating financial institutions that already allow the acceptance of cash and checks at their Bank ATM/KIOSK machines in order to facilitate the creation of a relationship with non-banking customers. The agent's ATM/Kiosk can also allow the customer to scan a barcode from their cell phone and immediately pay a bill or transfer cash to a family member or friend without the need to establish or qualify for a bank account. Enrollment at the ATM/KIOSK is fast and simple and the cell phone number is the account number, void any reference to the identity of the customer, so that identity theft is impossible short of armed robbery.

The transaction system of the invention will create and maintain financial accounts on behalf of its customers. The system can maintain bill payment data so the customer can pay monthly bills after making a cash deposit at an ATM/KIOSK or at one of the participating financial institutions. All transactions are processed via the cell phone. No standing in lines at the grocery store, a bank, or Western Union to make a money transfer.

In one aspect, the customer will enter their cell phone number or scan a barcode from their phone at an ATM/KIOSK, and the agent does the rest. The system will ask for a pin code and if the customer's profile has been pre-established, the barcode selected by the customer will complete the money transfer or bill payment and send a receipt to the cell phone and/or email address. If the customer needs to add money, the ATM/KIOSK will accept the cash and confirm immediately the funds in the customer account. There is no need to complete forms to send money or to pay a bill, the agent will maintain the data and complete the transfer once the customer has confirmed the pin code. A family member or friend can pick up the cash at an ATM/KIOSK or at a participating financial institution with only a reference # & temporary pin code at a location close to them. Payment for goods and services to merchants is contemplated as well. In this case the mobile application uses the consumer's cellular phone as a secure credit card.

One embodiment of the invention provides a computer-implemented method for processing cash payment transactions initiated using a mobile telephone as a cash payment device at an automated teller machine or other functionally equivalent kiosk (hereinafter ATM/KIOSK). The method may generally include receiving a request to enroll a mobile telephone in a payment transaction system. The request may include an indication of an identity of an individual enrolling the mobile telephone and the telephone number of the mobile telephone. The method also includes establishing a bank account for the mobile telephone. The bank account is tied to both the individual and the telephone number of the mobile telephone received with the request. The method may also include providing a cash payment application for installation on the mobile telephone. The cash payment application, when executed on the mobile telephone, allows the individual to initiate cash payment transactions using the mobile telephone to authenticate a cash payment at an ATM/KIOSK.

Another embodiment of the invention includes a computer-readable storage medium containing a program, which, when executed on a processor performs an operation for processing cash payment transactions initiated using a mobile telephone as a cash payment device. The operation may generally include, receiving a request to enroll a mobile telephone in a cash payment transaction system. The request may include an indication of an identity of an individual enrolling the mobile telephone and the telephone number of the mobile telephone. The operation may also include establishing a bank account for the mobile telephone. The bank account is tied to both the individual and the telephone number of the mobile telephone received with the request. The operation may also include providing a cash payment application for installation on the mobile telephone. The cash payment application may be configured to allow the individual to initiate cash payment transactions using the mobile telephone to authenticate a cash payment at an ATM/KIOSK, when installed and executed on the mobile telephone.

Still another embodiment of the invention includes a system having a processor and a memory containing a transaction server, which when executed by the processor performs an operation for processing cash payment transactions initiated at an ATM/KIOSK using a mobile telephone as a cash payment device. The operation may generally include receiving a request to enroll a mobile telephone in a payment transaction system. The request includes an indication of an identity of an individual enrolling the mobile telephone and the telephone number of the mobile telephone. The operation may also include establishing a bank account for the mobile telephone. The bank account is tied to both the individual and the telephone number of the mobile telephone received with the request. The system also includes a cash payment application for installation on the mobile telephone. The cash payment application may be configured to communicate with the transaction server to initiate cash payment transactions using the mobile telephone to authenticate an ATM/KIOSK cash payment, once installed and executed on the mobile telephone.

More specifically, what is needed is a computer-implemented method for sending cash among customers of an authorized agent using ATM/KIOSKS, and cell phones of said customers, comprising the following steps:
(a) entities become customers of said agent by providing secret pin codes and cell phone numbers to uniquely indentify said customers to said agent, and by authorizing said agent to maintain financial accounts on behalf of said customers, said accounts being logically associated with information that uniquely identifies and links said cell phones to said customers using computer-implemented application software provided by said agent on said cell phones.
(b) said customers send cash to other said customers by inputting into said ATM/KIOSKS cash amounts, said pin codes and said cell phone numbers of said customers who are sending, and said cell phone numbers of said customers who are receiving said cash amounts.

Additional aspects of such a method may include: said step to send cash, also comprises said customers send cash debited against said financial accounts to other said customers; and said step to send cash, may also comprise said customers sending cash deposited into said ATM/KIOSKS to other said customers; and wherein said step to become customers, may also comprise said entities becoming customers of said agent by inputting into said ATM/KIOSKS, valid legal picture IDs, secret pin codes and cell phone numbers to uniquely indentify said customers to said agent, and by authorizing said agent to maintain financial accounts on behalf of said customers, said accounts being logically associated with information that uniquely identifies and links said cell phones to said customers using computer-implemented application software provided by said agent download to said cell phones; and wherein said step to become customers, may also comprise said entities becoming customers of said agent by inputting into said ATM/KIOSKS, credit card information; and wherein said step to become customers, may also comprise said entities becoming customers of said agent by inputting into said ATM/KIOSKS, bank account information; and wherein said step to become customers, may also comprise said entities become customers of said agent by inputting into said ATM/KIOSKS, thumbprint information.

In another aspect of the invention, a computer-implemented method is disclosed for processing cash payment transactions initiated using a mobile telephone as both a payment device and as an ATM/KIOSK authentication device for making cash deposits, comprising: receiving a request to enroll a mobile telephone in a payment transaction system, wherein the request includes an indication of an identity of an individual enrolling the mobile telephone and the telephone number of the mobile telephone; establishing a bank account for the mobile telephone, wherein the bank account is tied to both the individual and the telephone number of the mobile telephone received with the request; and providing a payment application for installation on the mobile telephone, wherein the payment application, when executed on the mobile telephone, allows the individual to initiate payment transactions using the mobile telephone as both the payment device and ATM/KIOSK authentication device for making cash payments. The computer-implemented method may also comprise, prior to establishing the bank account for the mobile telephone, validating the identity of the individual enrolling the mobile telephone and the telephone number of the mobile telephone; and may also comprise, wherein validating the identity of the individual enrolling the mobile telephone comprising confirming that a service provider has a mobile telephone account for the mobile telephone associated with a subscriber matching the identity of the individual; and may also comprise, receiving, from the payment application on the mobile telephone, a request to transfer funds to the bank account established for the mobile telephone; prompting the individual to select a source of funds for the transfer; initiating a transfer of funds from the selected source to the bank account established for the mobile telephone; and may also comprise, receiving, form the payment application on the mobile telephone, a request to initiate a payment transaction with a merchant; generating a payment code; transmitting the payment code to the payment application on the mobile telephone; receiving, from a point-of-sale system at the merchant, the payment code and a transaction amount; upon determining sufficient funds are available in the bank account established for the mobile telephone: transferring funds from the bank account established for the mobile telephone to an account associated with the merchant, and transmitting, to both the mobile telephone and the point of sale system, a confirmation that the payment transaction was completed successfully; and may also comprise, wherein the payment application on the mobile telephone is configured to generate, from the payment code, a machine readable barcode scanned by the point-of-sale system at the merchant; and may also comprise, wherein the payment application on the mobile telephone is configured to generate, from the payment code, an alphanumeric string keyed into the point-of-sale system at the merchant; and may also comprise, receiving, from the payment application on the mobile telephone, a request to transfer a specified amount of funds from the mobile telephone to a second mobile telephone enrolled in the payment transaction system; upon determining sufficient funds are available in the bank account established for the mobile telephone, prompting a second individual associated with the second mobile telephone to authorize the request to transfer funds; and upon receiving a confirmation from the second individual, transferring the specified amount of funds from the account established for the mobile telephone to an account established for the second mobile telephone, wherein the account established for the second mobile telephone is tied to both the second individual and a telephone number of the second mobile telephone.

In still another embodiment, a computer-readable storage medium is disclosed containing a program, which, when executed on a processor performs an operation for processing cash payment transactions initiated using a mobile telephone to authenticate a cash payment made at an ATM/KIOSK, the operation comprising: receiving a request to enroll a mobile telephone in a cash payment transaction system, wherein the request includes an indication of an identity of an individual enrolling the mobile telephone and the telephone number of the mobile telephone; establishing a bank account for the mobile telephone, wherein the bank account is tied to both the individual and the telephone number of the mobile telephone received with the request; and providing a cash payment application for installation on the mobile telephone, wherein the cash payment application, when installed and executed on the mobile telephone, allows the individual to initiate cash payment transactions using the mobile telephone to authenticate the identity of the individual making the cash payment at an ATM/KIOSK; and wherein the operation may also comprise, that prior to establishing the bank account for the mobile telephone, validating the identity of the individual enrolling the mobile telephone and the telephone number of the mobile telephone; and may also comprise, validating the identity of the individual enrolling the mobile telephone comprising confirming that a service provider has a mobile telephone account for the mobile telephone associated with a subscriber matching the identity of the individual; and may also comprise, receiving, from the cash payment application on the mobile telephone, a request to transfer funds to the bank account established for the mobile telephone; prompting the individual to select a source of funds for the transfer; and initiating a transfer of funds from the selected source to the bank account established for the mobile telephone; and may also comprise, receiving, form the cash payment application on the mobile telephone, a request to initiate a payment transaction with a merchant; generating a payment code; transmitting the payment code to the cash payment application on the mobile telephone; receiving, from a point-of-sale system at the merchant, the payment code and a transaction amount; upon determining sufficient funds are available in the bank account established for the mobile telephone: transferring funds from the bank account established for the mobile telephone to an account associated with the merchant, and transmitting, to both the mobile telephone and the point of sale system, a confirmation that the payment transaction was completed successfully; and may also comprise, the cash payment application on the mobile telephone being configured to generate, from the payment code, a machine readable barcode scanned by the point-of-sale system at the merchant; and may also comprise, the cash payment application on the mobile telephone being configured to generate, from the payment code, an alphanumeric string keyed into the point-of-sale system at the merchant; and may also comprise, receiving, from the cash payment application on the mobile telephone, a request to transfer a specified amount of funds from the mobile telephone to a second mobile telephone enrolled in the payment transaction system; upon determining sufficient funds are available in the bank account established for the mobile telephone, prompting a second individual associated with the second mobile telephone to authorize the request to transfer funds; and upon receiving a confirmation from the second individual, transferring the specified amount of funds from the account established for the mobile telephone to an account established for the second mobile telephone, wherein the account established for the second mobile telephone is tied to both the second individual and a telephone number of the second mobile telephone.

In still yet another embodiment, a system is disclosed, comprising: a processor and a memory containing a transaction server, which when executed by the processor performs an operation for processing cash payment transactions initiated using a mobile telephone to authenticate a cash payment deposited into an ATM/KIOSK, the operation comprising: receiving a request to enroll a mobile telephone in a payment transaction system, wherein the request includes an indication of an identity of an individual enrolling the mobile telephone and the telephone number of the mobile telephone, and establishing a bank account for the mobile telephone, wherein the bank account is tied to both the individual and the telephone number of the mobile telephone received with the request; and a cash payment application for installation on the mobile telephone, wherein the cash payment application, when installed and executed on the mobile telephone, communicates with the transaction server to initiate payment transactions using the mobile telephone to authenticate the identity of the individual making the cash payment deposit at an ATM/KIOSK; and may also comprise, prior to establishing the bank account for the mobile telephone, validating the identity of the individual enrolling the mobile telephone and the telephone number of the mobile telephone; and may also comprise, validating the identity of the individual enrolling the mobile telephone comprises confirming that a service provider has a mobile telephone account for the mobile telephone associated with a subscriber matching the identity of the individual; and may also comprise, receiving, from the cash payment application on the mobile telephone, a request to transfer funds to the bank account established for the mobile telephone; prompting the individual to select a source of funds for the transfer; initiating a transfer of funds from the selected source to the bank account established for the mobile telephone; and may also comprise, receiving, form the cash payment application on the mobile telephone, a request to initiate a payment transaction with a merchant; generating a payment code; transmitting the payment code to the payment application on the mobile telephone; receiving, from a point-of-sale system at the merchant, the payment code and a transaction amount; upon determining sufficient funds are available in the bank account established for the mobile telephone: transferring funds from the bank account established for the mobile telephone to an account associated with the merchant, and transmitting, to both the mobile telephone and the point of sale system, a confirmation that the payment transaction was completed successfully; and may also comprise, the cash payment application on the mobile telephone being configured to generate, from the payment code, a machine readable barcode scanned by the point-of-sale system at the merchant; and may also comprise, the cash payment application on the mobile telephone being configured to generate, from the payment code, an alphanumeric string keyed into the point-of-sale system at the merchant; and may also comprise, receiving, from the payment application on the mobile telephone, a request to transfer a specified amount of funds from the mobile telephone to a second mobile telephone enrolled in the payment transaction system; upon determining sufficient funds are available in the bank account established for the mobile telephone, prompting a second individual associated with the second mobile telephone to authorize the request to transfer funds; and upon receiving a confirmation from the second individual, transferring the specified amount of funds from the account established for the mobile telephone to an account established for the second mobile telephone, wherein the account established for the second mobile telephone is tied to both the second individual and a telephone number of the second mobile telephone.

### ADVANTAGES OF THE INVENTION

Secure Access: consumers do not have convenient secure access to private global banking/payment and credit card networks.

SUBSTITUTE SPECIFICATION

Immediate cleared funds: currently there is no secure consumer convenience which can provide immediate cleared funds across different bank accounts and credit/debit cards. It may take 24 hours for bank to bank ACH transfers and it could be expensive.

Unified solution: no one company provides a complete unified solution to handle Credit/Debit cards, loyalty cards, coupons and gift cards in one package.

Flexible: secure mobile application facilitates peer to peer, merchant, credit card, interbank and intra bank funds transfers.

Eliminate the need to use physical credit cards/debit cards/loyalty cards/gift cards, etc.

Provide consumers the ability to make purchases via the internet/cell phone/POS without ever having to disclose a credit card number. This practically eliminates consumer phobia of security.

Offer customers simple, safe and secure transactions which can provide immediate cleared funds globally.

Transparently utilizes the existing payment networks and POS systems to which, most consumers are already use to, without need of additional hardware such as NFC, and the like.

Allow ease of money transfer globally from anywhere to anywhere.

Virtual credit card generated for a fixed time (i.e. 15 min max) only valid for one transaction.

Unique and auditable transaction code for tracking

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is part of a generalized flow diagram illustrating a mobile telephone transaction system, according to one embodiment of the invention.

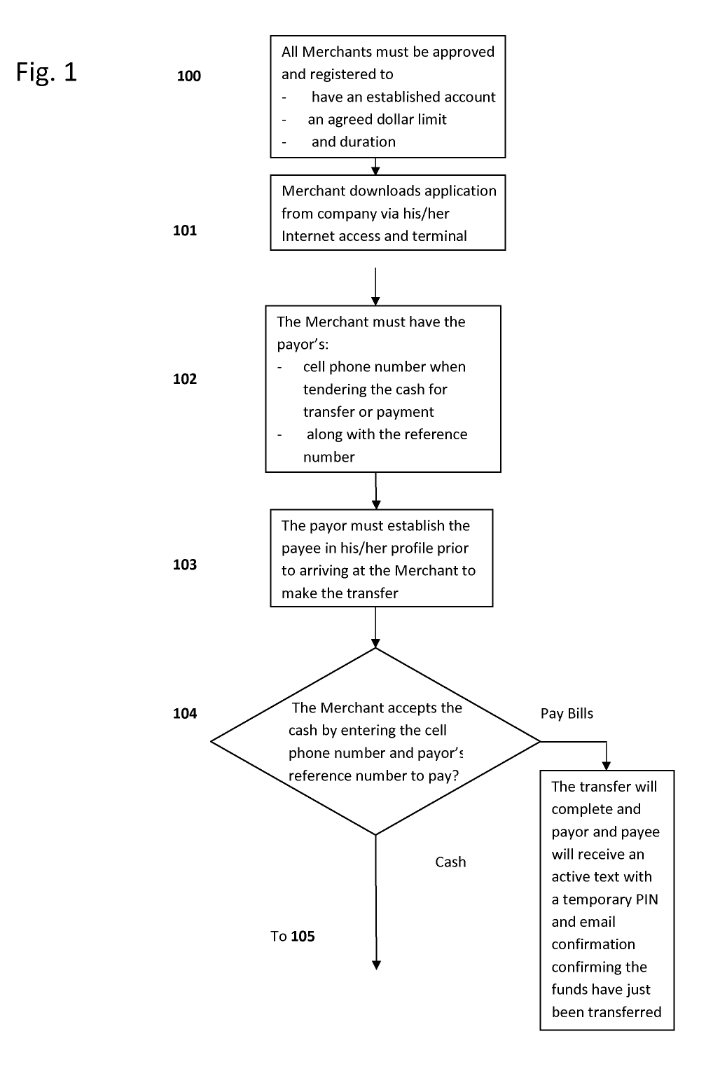

FIG. 2 is part of a generalized flow diagram further illustrating a transaction server configured to allow a mobile telephone to participate in a payment transaction, according to one embodiment of the invention.

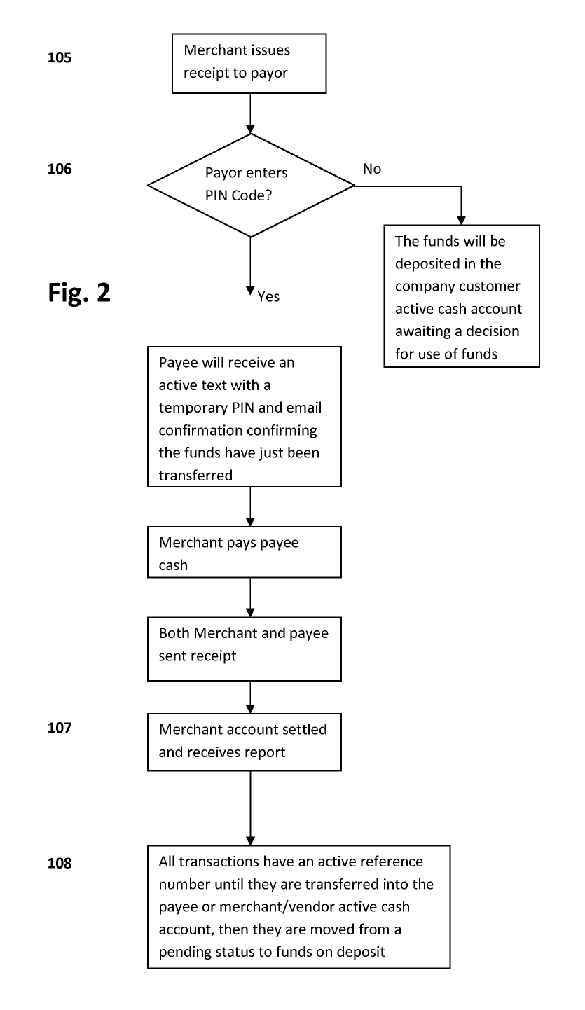

FIG. 3 is part of a flow diagram further illustrating components of a mobile telephone transaction system configured to engage in authentication and deposit/withdrawal transactions, according to one embodiment of the invention.

FIG. 4 is part of a flow diagram illustrating a method for enrolling a mobile telephone in a mobile telephone transaction system via an ATM/KIOSK, according to one embodiment of the invention.

FIG. 5 is a flow diagram illustrating a method for a funds transfer in a mobile telephone transaction system according to one embodiment of the invention.

FIGS. 8A-B are examples of graphical user interfaces displays on a mobile telephone device configured to participate in payment transactions, according to one embodiment of the invention.

### DETAILED DESCRIPTION OF THE PREFERRED EMBODIMENTS

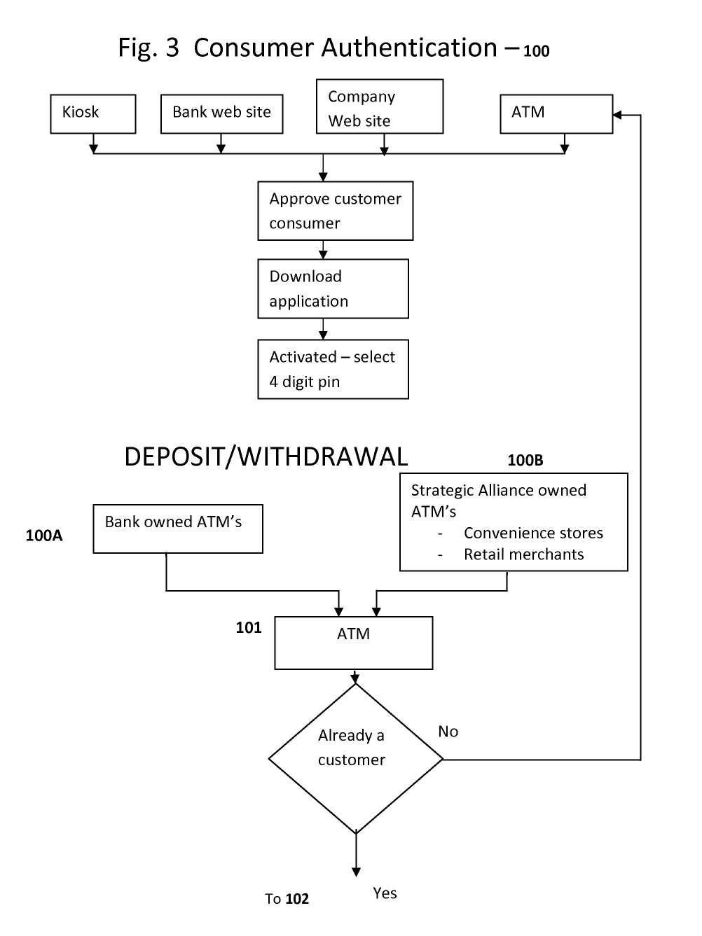

A new customer consumer must be authenticated (FIG. 3, 100) to download the application and receive all customer services, which will include access to applicant company's ATM Cash Acceptance Module. A Secret Code four digit pin is selected by the customer consumer at the time of this company application download. These independent ATM/KIOSKS may also be used for the company authentication process as well.

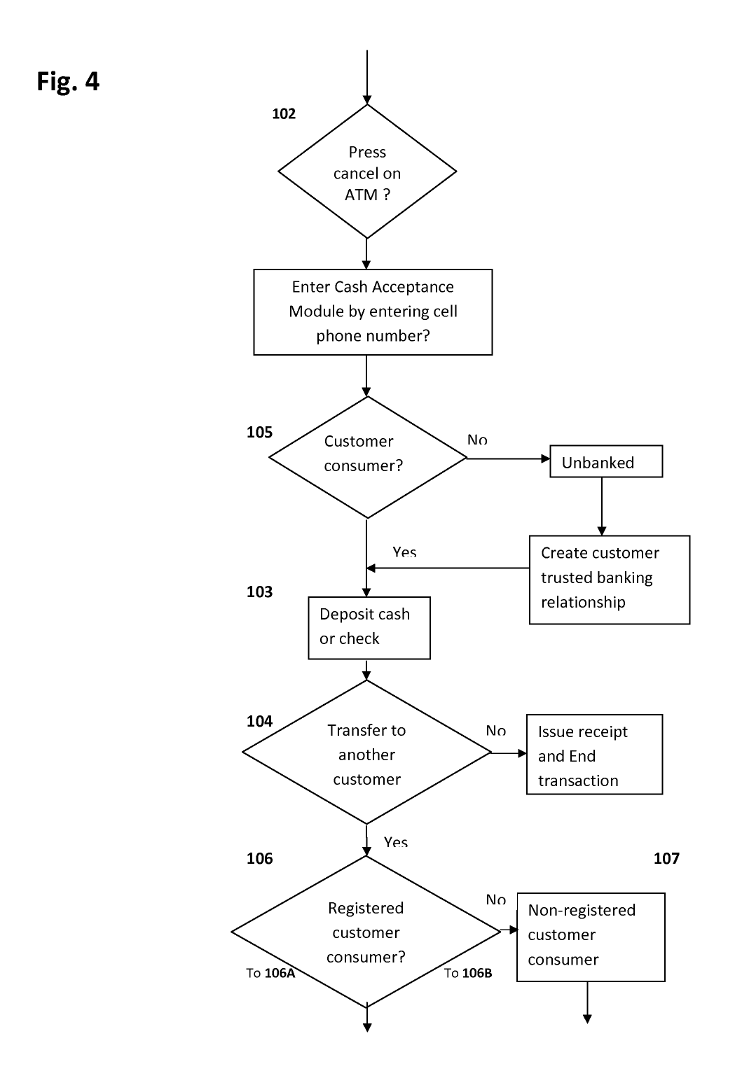

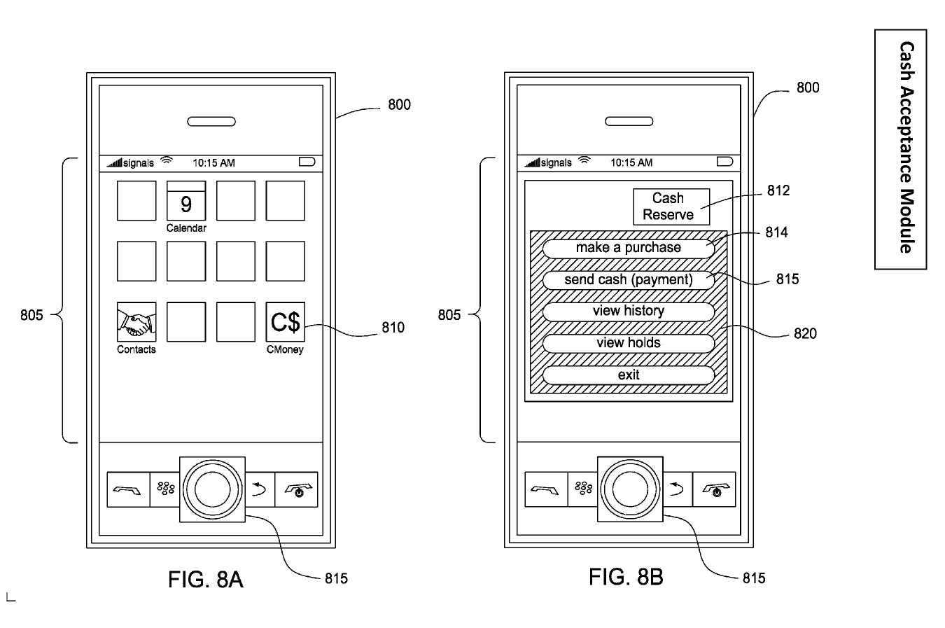

ATM Cash Acceptance Module FIG. 8B as it relates to selections within 820 at 815, wherein the company cell phone application and transaction server method allow the complete integration of ATM/KIOSKS at either local banks (FIG. 3, 100A) or independent ATM/KIOSK machines (100B) managed via Strategic Alliances that enable the company Repository Bank to accept cash at the ATM/KIOSK (101) for deposit via FIG. 8A, 805. A customer consumer—payor—at the bank ATM will initiate the “company ATM Cash Acceptance Module” by simply pressing the “Cancel” button (FIG. 4, 102) on the ATM machine at which time, the company application system will provide input access for the payor's cell phone number. The payor's ten digit cell phone number is entered which connects with the transaction server and enables the payor to make immediate deposits into an ATM/KIOSK machine either at a local bank or via an independent ATM/KIOSK machine that may be installed at a convenience store or other retail merchant. These independent ATM/KIOSKS may also be used for company application registration process as well as the bank ATM/KIOSKS.

The payor makes a deposit (FIG. 4, 103) by simply entering only their cell phone number to access the company application pre-designated account that upon activation at an ATM/KIOSK, or via the Bank Website, and/or the company Website or ATM/KIOSK can have any payor immediately deposit funds—cash or check—to his/her respective account and this deposit will immediately appear as a credit on the cell phone under the company application, branded by the operating company.

The payor may use this company application to transfer funds (104) via the banking system using the company operating infrastructure to numerous bank accounts of other registered customer consumers—payees.

The unbanked consumer (105) now may establish a banking relationship via the company trusted account relationship for unbanked consumers.

Once cash is accepted via the company application, then transfers (106) can be made to other mobile customer consumers, merchants and bank to bank transfers. The ATM/KIOSK which accepts the cash, then allows the consumer to access an ATM/KIOSK cash transfer from any bank ATM/KIOSK that accepts the company application infrastructure, which alternatively will ask for a cell phone number—as opposed to your traditional ATM/KIOSK Debit Card—and Secret Code four digit pin. At the same time their selected digit pin is used to access funds and make company application transfers, when the consumer is using ATM/KIOSK Cash Acceptance Module to be paid for goods or services then the company payor must provide a onetime “pin” and their cell phone number to make the deposit at the participating ATM BANK. All company application cell phone transactions still require a reference code and a four digit pin to accept and complete the transaction for verification of identity. A pin must be entered whether a payor is depositing to a cell phone number or a payee is withdrawing cash from a pending “Will Call” Transaction.

Non-registered company consumer—payee, a friend or business acquaintance—may withdraw (107) a payor transfer via the “Will Call” system one time only via any ATM/KIOSK that is registered with the company. This “Will Call” system will notify a payee via the SMS system that funds are being held under their respective cell phone number at any repository company bank and the payor of the transfer must provide the generated unique company Reference number and One Time Use “Will Call PIN”. This “Will Call PIN” and unique reference number is received via the SMS system for a onetime payor transfer where the payee may be unable to download the company application but can receive the “Will Call PIN” and Reference number.

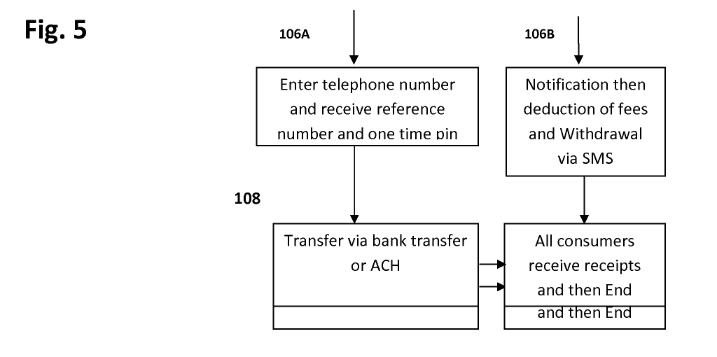

The Payee will then obtain the cash at any participating company repository bank (FIG. 5, 108).

Instant Transfers on the company application “Will Call” system have various fees deducted from the companies' payor's bank account depending on the dollar amount of the transaction (108). A higher fee is levied on non -company payees who use the “Will Call” system. A company customer payor may deposit any amount of money at a participating bank ATM/KIOSK at any hour of the day or night and the company system will verify and send a special alert to the payee that a deposit has been made to his/her third party agent company account and the transaction will remain in “pending status” of the company payee's account until the payee accepts and designates the company customer account holder as to where it is to be routed. The payee may choose to route to any bank account or credit card accounts registered via the repository bank of company. Cash withdrawals are only via the ATM/KIOSK.

A company customer payor may also request a bank transfer or overnight ACH payment (108) to any payee. All registered company payors will receive instant transfer notification via SMS once the transaction to be transferred has been initiated by the payor for transfer.

The payor, who made the deposit to the Bank “ATM/KIOSK” will receive tracking information via the SMS system confirming the acceptance of the deposit plus the acceptance alert notice when the payee has successfully obtained and confirmed the transfer. All transactions have a unique reference number which is generated by the company application and sent via SMS to the cell phone of the company customer payor alerting the payor that a deposit is in pending status. This reference number allows the payee to expedite a “Will Call” status on this deposit or a portion of the deposit, and then the company system will assign a reference number and one time “pin” for the “Will Call Pickup”. This reference number will also allow the payor or payee to contact the company application “Help Desk” regarding a particular transaction, including the cancellation of a transaction.

Once the transaction has been accepted by the company Repository bank via the “ATM/KIOSK” the funds are then available for bank to bank transfer, retail purchases via the barcode/paycode system offered by the company application or the company “Will Call” system for an immediate cash transfer (108). Every retail outlet when registered with company application may initiate a “Will Call Transfer or Pickup of Funds”. At the “ATM/KIOSK” when accessing the “company “ATM/KIOSK” Cash Acceptance Module” a “Will Call” may be cancelled only by the company customer payor using their assigned “pin” number and reference number assigned to the cash captured at the Bank “ATM/KIOSK” using the “ATM/KIOSK” Cash Acceptance Module from a participating company bank “ATM/KIOSK” or via calling the company “Help Desk”.

All company application transactions have an audit trail and receipts issued to all consumers.

All Merchants must be approved and registered to offer this service, by the company, which offers an alternative process for transferring money or paying a bill by using the company Merchant Transfer system offered via the company application wherein a registered Merchant may accept and receive cash payments and enter these payments into the company application system for transfer either to another participating consumer or another participating merchant who uses the company application system. The company assumes only the risk of the Merchant application wherein the Merchant must have an established account, an agreed dollar limit and duration with the operating company to allow the transfers to be completed.

Once the consumers (payor) cash is tendered to the merchant, the payor must have his/her cellphone in their possession to make the transfer and request a merchant transfer reference number which in turn is given to the merchant who is accepting the cash for transfer or payment of bill owed by the Payor. The payor must establish a person whom they wish to remit a payment to in the company system which in turn allows that consumer (payee) to request a merchant transfer reference number once the cash is accepted by the Merchant from the Payor. The Merchant must have a computer terminal available with Internet access in order to use this company application.

The Merchant must have the payor's cell phone number when tendering the cash for transfer or payment along with the reference number issued to the payor as to where the funds are to be transferred to or a payment is to be made. The payor must establish the payee in his/her profile prior to arriving at the Merchant to make the transfer.

Once the payor tenders cash and the reference number to the Merchant, the Merchant accepts the cash by entering the cell phone number and payor's reference number. Merchant will give the payor a receipt and immediately the payor will receive notification on his/her cell phone that a pending payment profile or transfer profile has been funded by a Merchant. . Once payor pin is correctly entered and verified the transfer will complete and payor and payee will receive an active text with a temporary pin and email confirmation confirming the funds have just been transferred. The participating Merchant account will be settled in a batch format for the day. Those merchants transferring dollar amounts over their agreed dollar amount need to subscribe to “ATM/KIOSK” Cash Module and have funds deposited direct to the company ATM/KIOSK wherein the company application maintains and verifies online balances. A daily report is generated to the Merchant with the transfers for each “ATM/KIOSK” machine.

Should a payor not put in the pin to accept and agree to the terms of the transfer to another company payee or merchant/vendor payee, then the funds will be deposited in the company customer active cash account awaiting a decision for use of funds.

The payee may pick up cash at another company “ATM/KIOSK” machine with a temporary PIN and reference number. Those Bill pays will be sent to merchant/vendor per the profile established by the payor showing account number and amount of transfer for payment of a bill. All transactions have an active reference number until they are transferred into the payee or merchant/vendor active cash account, then they are moved from a pending status to funds on deposit. These funds can only be retrieved via the company operating application.

Advantageously, as described herein, embodiments of the invention allow a mobile telephone, in conjunction with an ATM/KIOSK and a payment transaction server, to be used directly as a cash payment device for a variety of financial transactions. Further, the transaction systems and methods for mobile telephone devices described herein allow a mobile telephone to authenticate an ATM/KIOSK cash deposit and to participate in payment transactions in a manner that both prevent identify theft and does not rely on transferring amounts to/from one stored value account to another.

While the foregoing is directed to embodiments of the present invention, other and further embodiments of the invention may be devised without departing from the basic scope thereof, and the scope thereof is determined by the claims that follow.

The previously described embodiments of the present invention have many advantages as disclosed. Although various aspects of the invention have been described in considerable detail with reference to certain preferred embodiments, many alternative embodiments are likely. Therefore, the spirit and scope of the claims should not be limited to the description of the preferred embodiments, nor the alternative embodiments, presented herein.

What is claimed is:

1. A computer-implemented method for sending cash among customers of an authorized agent using ATM/KIOSKS, and cell phones of said customers, comprising the following steps:
(a) entities become customers of said agent by providing secret pin codes and cell phone numbers to uniquely indentify said customers to said agent, and by authorizing said agent to maintain financial accounts on behalf of said customers, said accounts being logically associated with information that uniquely identifies and links said cell phones to said customers using computer-implemented application software provided by said agent on said cell phones.
(b) said customers send cash to other said customers by inputting into said ATM/KIOSKS cash amounts, said pin codes and said cell phone numbers of said customers who are sending, and said cell phone numbers of said customers who are receiving said cash amounts.

2. The method of claim 2 wherein said step to send cash, further comprises said customers send cash debited against said financial accounts to other said customers.

3. The method of claim 1 wherein said step to send cash, further comprises said customers send cash deposited into said ATM/KIOSKS to other said customers.

4. The method of claim 1, 2 or 3 wherein said step to become customers, further comprises said entities become customers of said agent by inputting into said ATM/KIOSKS, valid legal picture IDs, secret pin codes and cell phone numbers to uniquely indentify said customers to said agent, and by authorizing said agent to maintain financial accounts on behalf of said customers, said accounts being logically associated with information that uniquely identifies and links said cell phones to said customers using computer-implemented application software provided by said agent download to said cell phones.

5. The method of claim 4 wherein said step to become customers, further comprises said entities become customers of said agent by inputting into said ATM/KIOSKS, credit card information.

6. The method of claim 4 wherein said step to become customers, further comprises said entities become customers of said agent by inputting into said ATM/KIOSKS, bank account information.

7. The method of claim 4 wherein said step to become customers, further comprises said entities become customers of said agent by inputting into said ATM/KIOSKS, thumbprint information.

8. A computer-implemented method for processing payment transactions initiated using a mobile telephone as both a payment device and as an ATM/KIOSK authentication device for making cash deposits, comprising: receiving a request to enroll a mobile telephone in a payment transaction system, wherein the request includes an indication of an identity of an individual enrolling the mobile telephone and the telephone number of the mobile telephone; establishing a bank account for the mobile telephone, wherein the bank account is tied to both the individual and the telephone number of the mobile telephone received with the request; and providing a payment application for installation on the mobile telephone, wherein the payment application, when executed on the mobile telephone, allows the individual to initiate payment transactions using the mobile telephone as both the payment device and ATM/KIOSK authentication device for making cash payments.

9. The computer-implemented method of claim 8, further comprising, prior to establishing the bank account for the mobile telephone, validating the identity of the individual enrolling the mobile telephone and the telephone number of the mobile telephone.

10. The computer-implemented method of claim 9, wherein validating the identity of the individual enrolling the mobile telephone comprises confirming that a service provider has a mobile telephone account for the mobile telephone associated with a subscriber matching the identity of the individual.

11. The computer-implemented method of claim 8, further comprising: receiving, from the payment application on the mobile telephone, a request to transfer funds to the bank account established for the mobile telephone; prompting the individual to select a source of funds for the transfer; initiating a transfer of funds from the selected source to the bank account established for the mobile telephone.

12. The computer-implemented method of claim 11, further comprising: receiving, form the payment application on the mobile telephone, a request to initiate a payment transaction with a merchant; generating a payment code; transmitting the payment code to the payment application on the mobile telephone; receiving, from a point-of-sale system at the merchant, the payment code and a transaction amount; upon determining sufficient funds are available in the bank account established for the mobile telephone: transferring funds from the bank account established for the mobile telephone to an account associated with the merchant, and transmitting, to both the mobile telephone and the point of sale system, a confirmation that the payment transaction was completed successfully.

13. The computer-implemented method of claim 12, wherein the payment application on the mobile telephone is configured to generate, from the payment code, a machine readable barcode scanned by the point-of-sale system at the merchant.

14. The computer-implemented method of claim 12, wherein the payment application on the mobile telephone is configured to generate, from the payment code, an alphanumeric string keyed into the point-of-sale system at the merchant.

15. The computer-implemented method of claim 11, further comprising: receiving, from the payment application on the mobile telephone, a request to transfer a specified amount of funds from the mobile telephone to a second mobile telephone enrolled in the payment transaction system; upon determining sufficient funds are available in the bank account established for the mobile telephone, prompting a second individual associated with the second mobile telephone to authorize the request to transfer funds; and upon receiving a confirmation from the second individual, transferring the specified amount of funds from the account established for the mobile telephone to an account established for the second mobile telephone, wherein the account established for the second mobile telephone is tied to both the second individual and a telephone number of the second mobile telephone.

16. A computer-readable storage medium containing a program, which, when executed on a processor performs an operation for processing cash payment transactions initiated using a mobile telephone to authenticate a cash payment made at an ATM/KIOSK, the operation comprising: receiving a request to enroll a mobile telephone in a cash payment transaction system, wherein the request includes an indication of an identity of an individual enrolling the mobile telephone and the telephone number of the mobile telephone; establishing a bank account for the mobile telephone, wherein the bank account is tied to both the individual and the telephone number of the mobile telephone received with the request; and providing a cash payment application for installation on the mobile telephone, wherein the cash payment application, when installed and executed on the mobile telephone, allows the individual to initiate cash payment transactions using the mobile telephone to authenticate the identity of the individual making the cash payment at an ATM/KIOSK.

17. The computer-readable storage medium of claim 16, wherein the operation further comprises, prior to establishing the bank account for the mobile telephone, validating the identity of the individual enrolling the mobile telephone and the telephone number of the mobile telephone.

18. The computer-readable storage medium of claim 17, wherein validating the identity of the individual enrolling the mobile telephone comprises confirming that a service provider has a mobile telephone account for the mobile telephone associated with a subscriber matching the identity of the individual.

19. The computer-readable storage medium of claim 16, wherein the operation further comprises: receiving, from the cash payment application on the mobile telephone, a request to transfer funds to the bank account established for the mobile telephone; prompting the individual to select a source of funds for the transfer; and initiating a transfer of funds from the selected source to the bank account established for the mobile telephone.

20. The computer-readable storage medium of claim 19, wherein the operation further comprises: receiving, form the cash payment application on the mobile telephone, a request to initiate a payment transaction with a merchant; generating a payment code; transmitting the payment code to the cash payment application on the mobile telephone; receiving, from a point-of-sale system at the merchant, the payment code and a transaction amount; upon determining sufficient funds are available in the bank account established for the mobile telephone: transferring funds from the bank account established for the mobile telephone to an account associated with the merchant, and transmitting, to both the mobile telephone and the point of sale system, a confirmation that the payment transaction was completed successfully.

21. The computer-readable storage medium of claim 20, wherein the cash payment application on the mobile telephone is configured to generate, from the payment code, a machine readable barcode scanned by the point-of-sale system at the merchant.

22. The computer-readable storage medium of claim 20, wherein the cash payment application on the mobile telephone is configured to generate, from the payment code, an alphanumeric string keyed into the point-of-sale system at the merchant.

23. The computer-readable storage medium of claim 19, wherein the operation further comprises: receiving, from the cash payment application on the mobile telephone, a request to transfer a specified amount of funds from the mobile telephone to a second mobile telephone enrolled in the payment transaction system; upon determining sufficient funds are available in the bank account established for the mobile telephone, prompting a second individual associated with the second mobile telephone to authorize the request to transfer funds; and upon receiving a confirmation from the second individual, transferring the specified amount of funds from the account established for the mobile telephone to an account established for the second mobile telephone, wherein the account established for the second mobile telephone is tied to both the second individual and a telephone number of the second mobile telephone.

24. A system, comprising: a processor and a memory containing a transaction server, which when executed by the processor performs an operation for processing cash payment transactions initiated using a mobile telephone to authenticate a cash payment deposited into an ATM/KIOSK, the operation comprising: receiving a request to enroll a mobile telephone in a payment transaction system, wherein the request includes an indication of an identity of an individual enrolling the mobile telephone and the telephone number of the mobile telephone, and establishing a bank account for the mobile telephone, wherein the bank account is tied to both the individual and the telephone number of the mobile telephone received with the request; and a cash payment application for installation on the mobile telephone, wherein the cash payment application, when installed and executed on the mobile telephone, communicates with the transaction server to initiate payment transactions using the mobile telephone to authenticate the identity of the individual making the cash payment deposit at an ATM/KIOSK.

25. The system of claim 24, wherein the operation further comprises, prior to establishing the bank account for the mobile telephone, validating the identity of the individual enrolling the mobile telephone and the telephone number of the mobile telephone.

26. The system of claim 25, wherein validating the identity of the individual enrolling the mobile telephone comprises confirming that a service provider has a mobile telephone account for the mobile telephone associated with a subscriber matching the identity of the individual.

27. The system of claim 24, wherein the operation further comprises: receiving, from the cash payment application on the mobile telephone, a request to transfer funds to the bank account established for the mobile telephone; prompting the individual to select a source of funds for the transfer; initiating a transfer of funds from the selected source to the bank account established for the mobile telephone.

28. The system of claim 27, wherein the operation further comprises: receiving, form the cash payment application on the mobile telephone, a request to initiate a payment transaction with a merchant; generating a payment code; transmitting the payment code to the payment application on the mobile telephone; receiving, from a point-of-sale system at the merchant, the payment code and a transaction amount; upon determining sufficient funds are available in the bank account established for the mobile telephone: transferring funds from the bank account established for the mobile telephone to an account associated with the merchant, and transmitting, to both the mobile telephone and the point of sale system, a confirmation that the payment transaction was completed successfully.

29. The system of claim 28, wherein the cash payment application on the mobile telephone is configured to generate, from the payment code, a machine readable barcode scanned by the point-of-sale system at the merchant.

30. The system of claim 28, wherein the cash payment application on the mobile telephone is configured to generate, from the payment code, an alphanumeric string keyed into the point-of-sale system at the merchant.

31. The system of claim 27, wherein the operation further comprises: receiving, from the payment application on the mobile telephone, a request to transfer a specified amount of funds from the mobile telephone to a second mobile telephone enrolled in the payment transaction system; upon determining sufficient funds are available in the bank account established for the mobile telephone, prompting a second individual associated with the second mobile telephone to authorize the request to transfer funds; and upon receiving a confirmation from the second individual, transferring the specified amount of funds from the account established for the mobile telephone to an account established for the second mobile telephone, wherein the account established for the second mobile telephone is tied to both the second individual and a telephone number of the second mobile telephone.
